(19) United States
(12) Patent Application Publication
(10) Pub. No.: US 2008/0307106 A1
(43) Pub. Date: Dec. 11, 2008

(54) Photo Streaming to Media Device

(75) Inventors: Jeffrey Miller, Mountain View, CA (US); Kevin Arnold, Los Gatos, CA (US)

Correspondence Address: FISH & RICHARDSON P.C., PO BOX 1022, MINNEAPOLIS, MN, 55440-1022, US

(73) Assignee: APPLE INC., Cupertino, CA (US)

(21) Appl. No.: 11/779,018

(22) Filed: Jul. 17, 2007

Related U.S. Application Data
(60) Provisional application No. 60/942,994, filed on Jun. 8, 2007.

(51) Int. Cl. G06F 15/16

(52) U.S. Cl. 709/231

(57) ABSTRACT

Methods, systems, and apparatus for streaming images to a media device. In one aspect, a method includes receiving from a server an image listing comprising a database identifying one or more images stored on the server; presenting to a user a menu of albums, each album having one or more associated images, based on the image listing; receiving input from the user selecting an album from the menu of albums; transmitting to the server one or more image requests, wherein each image request corresponds to an image associated with the selected album; and generating output to a display device representing an image associated with the selected album based on image data received from the server in response to the image requests. Further, an audio clip associated with the selected album can be identified and one or more audio requests corresponding to the audio clip can be transmitted to the server.

This application claims the benefit of U.S. Provisional Application No. 60/942,994, filed Jun. 8, 2007. The disclosure of the prior application is considered part of (and is incorporated by reference in) the disclosure of this application.

### TECHNICAL FIELD

The present disclosure relates to media processing devices, and to systems and methods for streaming media content, such as images and music, to a media processing device in response to one or more requests.

### BACKGROUND

Media processing devices can be configured to present media files that contain audio, image, and/or video content. Early implementations required a user to download one or more entire media files to a local device before presentation could be initiated. The amount of time required to begin presentation depended on the size of the media files being transferred and the speed at which data could be transferred between the sending and receiving devices.

More recently, a remote media file that is to be presented can be progressively downloaded from a remote storage device. During progressive downloading, the portion of a media file downloaded to a local media processing device can be presented while one or more remaining portions of the media file are being downloaded. This technique of displaying a first portion of a media file while an additional portion of the media file is downloading is referred to as “streaming.” As an example of streaming, the website www.apple.com/trailers hosts movie trailers, the contents of which can be progressively downloaded to a local media processing device and viewed using the QuickTime media player distributed by Apple Inc., Cupertino, Calif. Nonetheless, through progressive downloading, the media file is downloaded sequentially.

A media file, such as a slide show including one or more images and one or more audio clips, can be presented through a media processing device. As with other media files, however, the one or more media files from which the slide show is generated must be transferred to and stored on, at least in part, the local media processing device before presentation of the slide show can begin. Thus, all of the resources required for the slide show are accessed locally at the media processing device during a presentation. Further, the slide show content is defined before the slide show is transferred to the media device and is therefore static.

### SUMMARY

A media processing device, such as a media client, can be configured to present a streaming presentation, e.g. a slide show, by issuing requests to a server for media content. Further, the media client can be configured to select at least a portion of the media content for the streaming presentation based on user preferences. In order to permit more flexible presentation of media content and to reduce the need to persistently store media content on the media client, the present inventors recognized that it was beneficial to permit a media client to issue requests to a media server for media content as the media content is needed, such as for presentation on a display device.

The present inventors also recognized a need for a media server to provide a list or inventory of available media content to a media client, such as in response to a request by the media client. Further, the need for a media server to provide an update to the media client when the available media content changes also was recognized. Additionally, the present inventors also recognized the need to permit downloading individual items of media content as they are needed, so that a presentation can be initiated before all items of media content associated with the presentation have been downloaded to the media playback device. Accordingly, the techniques and apparatus described here implement algorithms for accessing, downloading, and playing back media content in a non-sequential manner.

In general, in one aspect, the subject matter can be implemented to include receiving from a server an image listing comprising a database identifying one or more images stored on the server; presenting to a user a menu of albums, each album having one or more associated images, based on the image listing; receiving input from the user selecting an album from the menu of albums; transmitting to the server one or more image requests, wherein each image request corresponds to an image associated with the selected album; and generating output to a display device representing an image associated with the selected album based on image data received from the server in response to the one or more image requests.

The subject matter also can be implemented to include receiving an update to the image listing received from the server; and applying the update to the image listing before presenting the menu of albums. Further, the subject matter can be implemented to include processing the image listing in accordance with one or more user preferences before presenting the menu of albums. Additionally, the subject matter can be implemented such that the image listing comprises one of a binary database and an extensible markup language database.

The subject matter also can be implemented such that a unique identifier is associated with each image included in the image listing. Further, the subject matter can be implemented to include identifying an audio clip associated with the selected album and transmitting to the server one or more audio requests, wherein each audio request corresponds to the identified audio clip. Additionally, the subject matter can be implemented such that the one or more image requests comprise Hypertext Transfer Protocol requests.

In general, in another aspect, the subject matter can be implemented as a computer program product, encoded on a computer-readable medium, operable to cause data processing apparatus to perform operations comprising receiving from a server an image listing comprising a database identifying one or more images stored on the server; presenting to a user a menu of albums, each album having one or more associated images, based on the image listing; receiving input from the user selecting an album from the menu of albums; transmitting to the server one or more image requests, wherein each image request corresponds to an image associated with the selected album; and generating output to a display device representing an image associated with the selected album based on image data received from the server in response to the one or more image requests.

The subject matter also can be implemented to be further operable to cause data processing apparatus to perform operations comprising receiving an update to the image listing received from the server and applying the update to the image listing before presenting the menu of albums. Further, the subject matter can be implemented to be further operable to cause data processing apparatus to perform operations comprising processing the image listing in accordance with one or more user preferences before presenting the menu of albums. Additionally, the subject matter can be implemented such that the image listing comprises one of a binary database and an extensible markup language database.

The subject matter also can be implemented such that a unique identifier is associated with each image included in the image listing. Further, the subject matter can be implemented to be further operable to cause data processing apparatus to perform operations comprising identifying an audio clip associated with the selected album and transmitting to the server one or more audio requests, wherein each audio request corresponds to the identified audio clip. Additionally, the subject matter can be implemented such that the one or more image requests comprise Hypertext Transfer Protocol requests.

In general, in another aspect, the subject matter can be implemented as a system comprising a server; a display device; a user interface; and a media device configured to perform operations comprising receiving from the server an image listing comprising a database identifying one or more images stored on the server; presenting on the display device a menu of albums, each album corresponding to one or more images, based on the image listing; receiving through the user interface input selecting an album from the menu of albums; transmitting to the server one or more image requests, wherein each image request corresponds to an image associated with the selected album; and generating output to the display device representing an image associated with the selected album based on image data received from the server in response to the one or more image requests.

The subject matter also can be implemented such that the media device configured to perform operations comprising receiving an update to the image listing received from the server; and applying the update to the image listing before presenting the menu of albums. Further, the subject matter can be implemented such that the media device configured to perform operations comprising processing the image listing in accordance with one or more user preferences before presenting the menu of albums. Additionally, the subject matter can be implemented such that the image listing comprises one of a binary database and an extensible markup language database.

The subject matter also can be implemented such that a unique identifier is associated with each image included in the image listing. Further, the subject matter can be implemented such that the media device configured to perform operations comprising identifying an audio clip associated with the selected album and transmitting to the server one or more audio requests, wherein each audio request corresponds to the identified audio clip. Additionally, the subject matter can be implemented such that the one or more image requests comprise Hypertext Transfer Protocol requests.

The techniques described in this specification can be implemented to realize one or more of the following advantages. For example, the techniques can be implemented such that items of media content can be individually requested during a presentation. The techniques also can be implemented such that items of media content can be stored on a remote server. Additionally, the techniques can be implemented to permit updating a presentation or collection of images, such as an album, at a central location and sharing the presentation or collection of images with one or more playback devices. The techniques also can be implemented such that a presentation can be dynamically generated using one or more images and one or more audio clips. The techniques further can be implemented to permit displaying a presentation before all of the resources associated with the presentation are available at the playback device.

The details of one or more implementations are set forth in the accompanying drawings and the description below. Other features and advantages will be apparent from the description and drawings, and from the claims.

### BRIEF DESCRIPTION OF THE DRAWINGS

FIG. 1 is an example of a media client.

FIG. 2 is an example of a media system including a media client.

FIG. 3 is an example of a user interface generated by a media client.

FIG. 4 is an example of a photos menu generated by a media client.

FIG. 5 shows a flowchart for displaying a list of available images on a display device.

FIG. 6 shows a flowchart for streaming images to a media client for presentation on a display device.

FIG. 7 shows a flowchart for streaming photos to a media device.

Like reference symbols indicate like elements throughout the specification and drawings.

### DETAILED DESCRIPTION

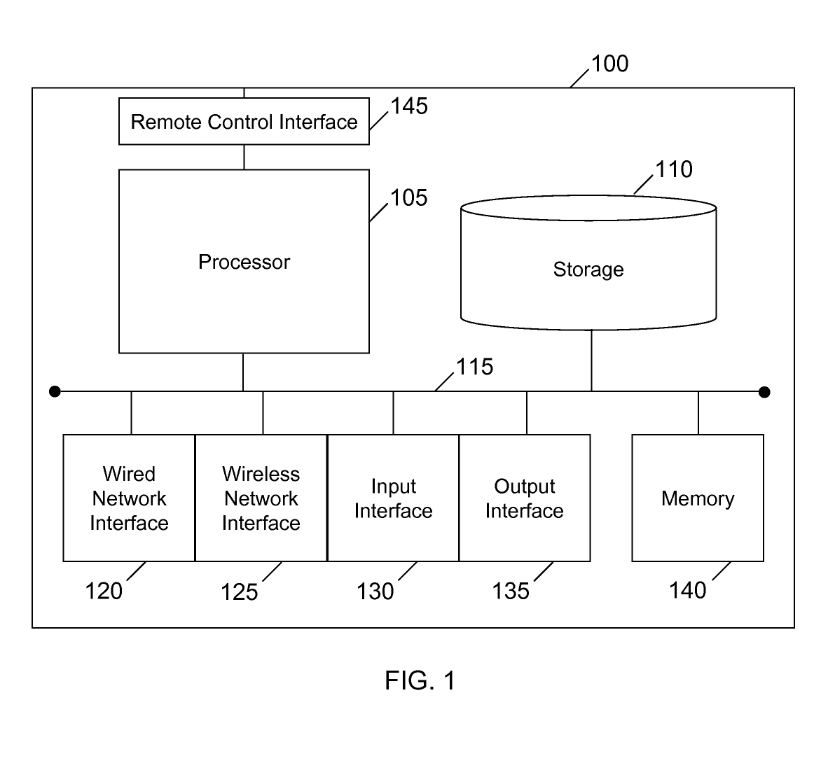

FIG. 1 shows a media client 100 that can be configured to present one or more types of media through a presentation device, including audio, video, images, or any combination thereof. The media client 100 includes a processor 105 configured to control the operation of the media client 100. For example, the processor 105 can control communications with one or more media servers to receive media for playback. A media server can be any general purpose server that provides access to media content. The media can be received through push and/or pull operations, including through downloading and streaming. The processor 105 also can be configured to generate output signals for presentation, such as one or more streams representing media content or an interface for interacting with a user.

The media client 100 also includes a storage device 110 that can be configured to store information including media, configuration data, user preferences, and operating instructions. The storage device 110 can be any type of non-volatile storage, including a hard disk device or a solid-state drive. For example, media received from an external media server can be stored on the storage device 110. The received media thus can be locally accessed and processed. Further, configuration information, such as the resolution of a coupled display device or information identifying an associated media server, can be stored on the storage device 110. Additionally, the storage device 110 can include one or more sets of operating instructions that can be executed by the processor 105 to control operation of the media client 100. In an implementation, the storage device 110 further can be divided into a plurality of partitions, wherein each partition can be utilized to store one or more types of information. Additionally, each partition can have one or more access control provisions.

A communication bus 115 couples the processor 105 to the other components and interfaces included in the media client 100. The communication bus 115 can be configured to permit unidirectional and/or bidirectional communication between the components and interfaces. For example, the processor 105 can retrieve information from and transmit information to the storage device 110 over the communication bus 115. In an implementation, the communication bus 115 can be comprised of a plurality of busses, each of which couples at least one component or interface of the media client 100 with another component or interface.

The media client 100 also includes a plurality of input and output interfaces for communicating with other devices, including media servers and presentation devices. A wired network interface 120 and a wireless network interface 125 each can be configured to permit the media client 100 to transmit and receive information over a network, such as a local area network (LAN) or the Internet. Additionally, an input interface 130 can be configured to receive input from another device through a direct connection, such as a USB or an IEEE 1394 connection.

Further, an output interface 135 can be configured to couple the media client 100 to one or more external devices, including a television, a monitor, an audio receiver, and one or more speakers. For example, the output interface 135 can include one or more of an optical audio interface, an RCA connector interface, a component video interface, and a High-Definition Multimedia Interface (HDMI). The output interface 135 also can be configured to provide one signal, such as an audio stream, to a first device and another signal, such as a video stream, to a second device. Further, a non-volatile memory 140, such as a read-only memory (ROM) also can be included in the media client 100. The non-volatile memory 140 can be used to store configuration data, additional instructions, such as one or more operating instructions, and values, such as one or more flags and counters. In an implementation, a random access memory (RAM) also can be included in the media client 100. The RAM can be used to store media content received in the media client 100, such as during playback. Further, media content can be stored in the RAM whether or not the media content is stored on the storage device 110.

Additionally, the media client 100 can include a remote control interface 145 that can be configured to receive commands from one or more remote control devices (not pictured). The remote control interface 145 can receive the commands through wireless signals, such as infrared and radio frequency signals. The received commands can be utilized, such as by the processor 105, to control media playback or to configure the media client 100. In an implementation, the media client 100 can be configured to receive commands from a user through a touch screen interface. The media client 100 also can be configured to receive commands through one or more other input devices, including a keyboard, a keypad, a touch pad, a voice command system, and a mouse.

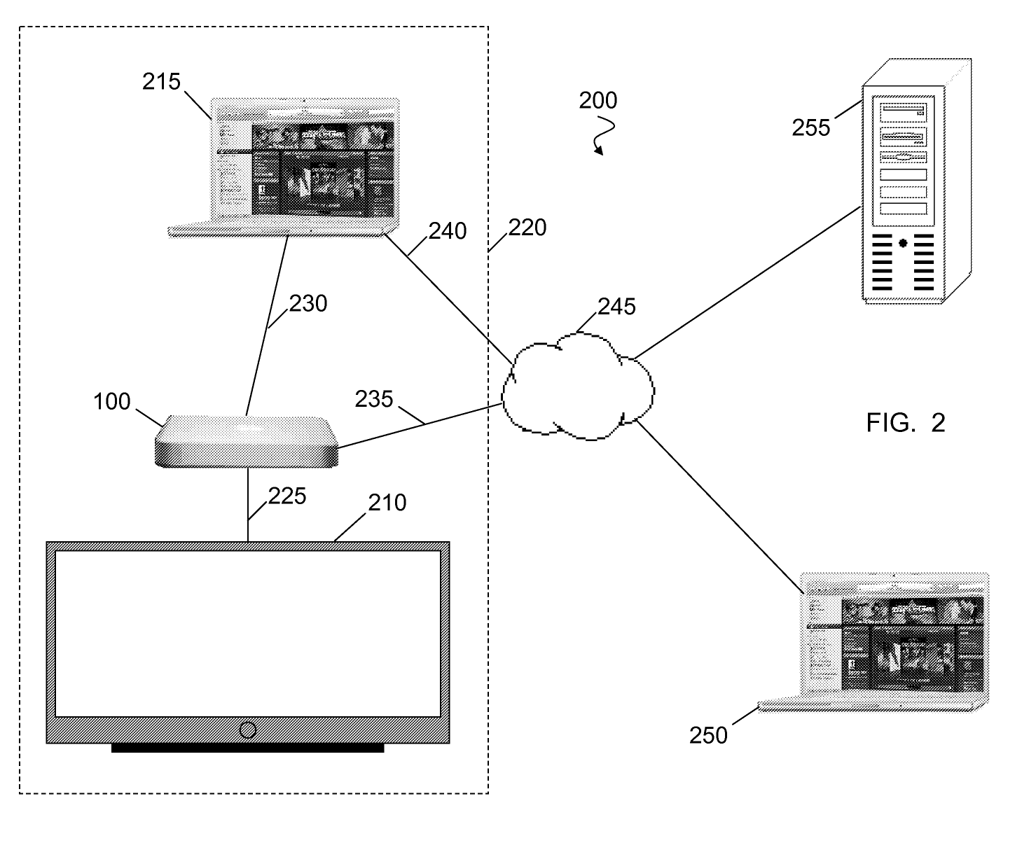

FIG. 2 shows a media system 200 that includes a media client 100. The media system 200 includes a host location 220, such as a home or office, in which the media client 100 is installed. The host location 220 also can include a local media server 215 and a presentation device, such as a monitor 210. The monitor 210 can be coupled to the media client 100 through a media connector 225, such that video and/or audio information output by the media client 100 can be presented through the monitor 210. Further, the media client 100 can be coupled to the local media server 215 through a local connection 230, such as a wired network connection, a wireless network connection, or a direct connection. As such, the media client 100 can receive media content from the local media server 215. The local media server 215 can be any computing device, including a personal computer, a server, a palm top computer, or a media device capable of storing and/or playing back media content.

Further, the media client 100 and the local media server 215 can include network connections 235 and 240 respectively, which provide access to a network 245, such as the Internet. In an implementation, the media client 100 can communicate with a remote media server 250 and/or a media store 255 over the network 245. For example, a connection can be established between the media client 100 and the remote media server 250. The connection can be secure or unsecure. Thereafter, the media client 100 can receive media content from the remote media server 250, such as by streaming or downloading.

Similarly, the media client 100 can be configured to receive media content from the media store 255. For example, upon establishing a connection, the media client 100 can request a list of available media content from the media store 255. The list of available media content can include free content, such as trailers, photo albums, free music, and podcasts, and for-purchase content, such as movies, television programs, and for-purchase music. Additionally, the media client 100 can be configured to communicate with the media store 255 to validate media content, such as by verifying digital rights management information.

Media content can be transferred from any remote server, such as the remote media server 250 or the media store 255, via one or more transmission protocols, including Hyper Text Transfer Protocol (HTTP). For example, the media client 100 can request media content from a remote media server 250. In response, the remote media server 250 can transmit the requested media content to the media client 100 using HTTP. The media content can be transferred using a plurality of data packets, which are separately transmitted over the network 245. Further, by utilizing HTTP version 1.1, the media client 100 can transmit a plurality of requests for media content to the remote server. The plurality of requests can be transmitted simultaneously or close in time, such that a request for media content is not delayed until a response to a previous request is received. As a result, latency in the transfer of requested media content can be reduced. Additionally, by utilizing HTTP version 1.1, one or more byte ranges can be identified to request specific portions of media content.

Media content also can be transferred from any local server, such as the local media server 215, via one or more transmission protocols. For example, if the local connection 230 is a wired network connection or a wireless network connection, the media client 100 can communicate with the local media server 215 using a network transfer protocol, such as HTTP, Digital Audio Access Protocol (DAAP), or Digital Photo Access Protocol (DPAP). Alternatively, if the local connection 230 is a direct connection, the media client 100 can receive one or more files from the local media server 215 directly.

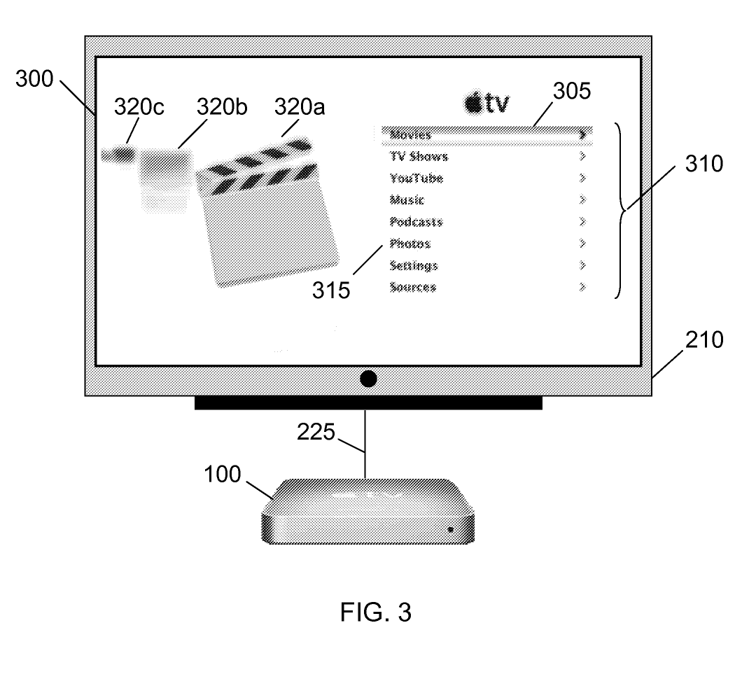

FIG. 3 shows a main menu 300 generated by the media client 100 and presented on the monitor 210. The main menu 300 displays a list of entries 310, including one or more configuration entries and/or content entries. For example, configuration entries permit a user to select a configuration option associated with the media client 100, including settings and sources. Further, content entries permit a user to select a category of content accessible on the media client 100, such as Movies, TV Shows, YouTube, Music, Podcasts, and Photos. The visibility of one or more entries of the list of entries 310 can be based on the capabilities of a media server with which the media client 100 is connected. For example, if the media client 100 is connected with a media server that is not configured to perform photo streaming, the entry corresponding to Photos can be omitted from the list of entries 310. Alternatively, a standard list of entries can be presented every time the main menu 300 is accessed.

The main menu 300 also includes cursor 305, which can be scrolled up and down in response to user input to a remote control device to designate an entry included in the list of entries 310. For example, the cursor 305 can be used to designate the Photos entry 315 in the list of entries 310. Further, the Photos entry 315 can be selected in response to one or more additional user inputs to the remote control device. Selecting the Photos entry 315 causes the media client 100 to display a photos menu 400. Additionally, the main menu 300 can include one or more icons or images which can be displayed in conjunction with the list of entries 310, such as icons 320a, 320b, and 320c. In an implementation, the largest displayed icon or image can correspond to the presently designated entry of the list of entries 310. Further, as the cursor 305 is scrolled through the list of entries 310, the display order and size of the one or more icons can change with the designated entry.

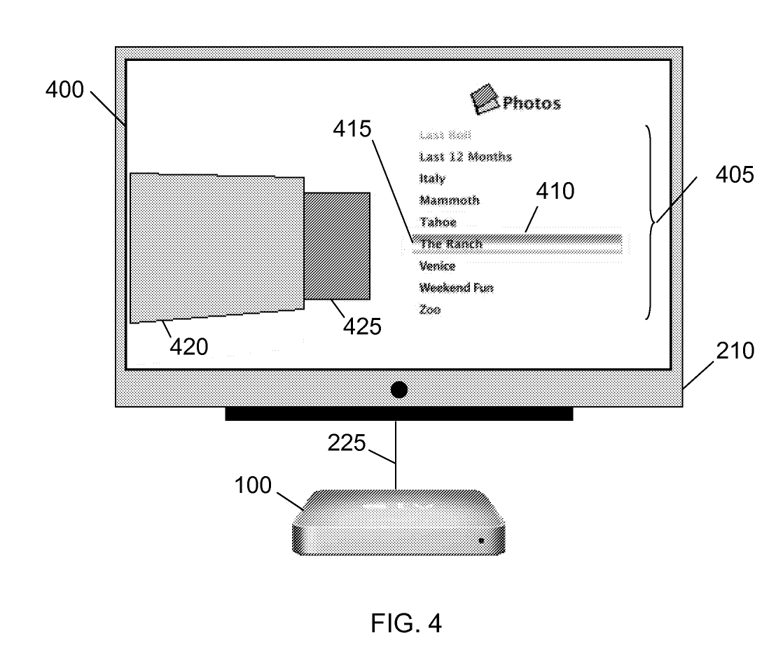

FIG. 4 shows the photos menu 400 generated by the media client 100 and presented on the monitor 210. The photos menu 400 displays one or more albums in a list of albums 405 that are available for presentation by the media client 100. An album can include one or more images that are associated through one or more common attributes, such as a storage location or a date of creation. For example, the list of albums 405 can include albums representing a period of time, such as Last Roll and Last 12 Months. Further, the list of albums 405 can include albums representing a particular event or location, such as Italy and Weekend Fun. The images represented by the one or more albums included in the list of albums 405 are stored on a remote server. In another implementation, the list of albums 405 also can include one or more albums for which the images are stored on the media client 100.

As with the main menu 300, a cursor 410 can be used to designate an album identified in the list of albums 405. For example, the cursor 410 can be scrolled through the list of albums 405 to designate the album titled The Ranch 415, which further can be selected in response to one or more additional user inputs to the remote control device. One or more images, such as the images 420 and 425 can be displayed in the photos menu 400. In an implementation, the images can correspond to the album presently designated by the cursor 410. The images displayed in the photos menu 400 also can be of lower resolution than the corresponding images included in the album, such as thumbnails. Additionally, the photos menu 400 can include one or more configuration categories, which can be selected to specify configuration parameters for the display of photos on the media client 100, such as user preferences and slide show settings. When an album is selected, such as the album titled The Ranch 415, the one or more images included in the album are presented in a slide show format on the monitor 210. The slide show also can include one or more audio clips, such as songs or narration. Additional details regarding the identification and transfer of audio information are set forth in U.S. Pat. No. 6,728,729, the entirety of which is incorporated herein by reference.

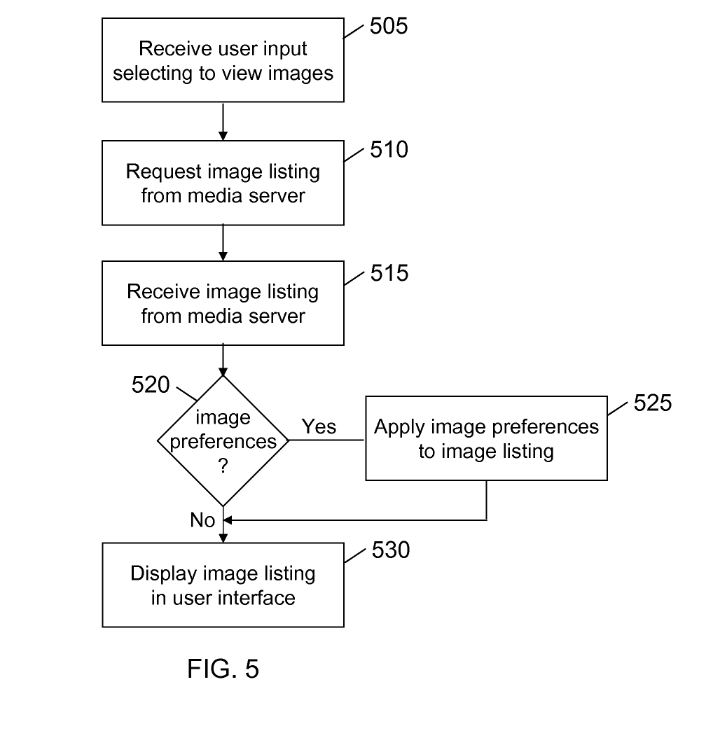

FIG. 5 shows a flowchart for displaying a list of available images on a display device. In an implementation, the list of available images can be organized as one or more albums, such that each album includes one or more images. Further, an album can be configured to include images related by one or more attributes, including physical attributes and thematic attributes. For example, images can be related by attributes such as storage location, file type, file creation date, a common file identifier, and/or previous viewing patterns. Additionally, the same image can be associated with more than one album.

The media client 100 receives user input, such as a command entered through a remote control, selecting to view images (505). For example, a media client 100 user can select a menu option to display a listing of images, such as photo albums or slide shows, available through the media client 100. Upon receiving the user input, the media client 100 requests an image listing from a media server (510). The media server can be any compatible server, including a local media server 215, a remote media server 250, or a media store 255. In an implementation, the media client 100 can be configured to obtain an image listing from a media server when an initial connection is made.

The media server generates a listing of the images available on the media server, including the albums or directories with which the images are associated. Additionally, the media server can identify a master album with which all of the viewable images stored on the media server are associated. The media server can be configured to identify and include all available images in the listing of images. Alternatively, the media server can be configured to limit the image listing based on one or more criteria stored at the media server or transmitted by the media client. For example, the media server can be instructed to search for available images only in predetermined locations, such as specific albums and/or preferred directories of a file system. The specific albums and/or directories can represent image containers that a user has configured the media server to share. User preferences indicating which images and image containers are to be shared further can be specified through one or more media server applications.

The media server also can be instructed to include in the image listing only files that are characterized by one or more predetermined attributes, including file type, file size, date, and owner. For example, the media server can be configured to share an image only if it is of a type that is supported by the media client. Filtering can be performed on a per image basis, such that one or more images can be excluded from an otherwise shared album. Similarly, the media client can be configured to access or request an image only if it is of a type that is supported by the media client.

The media client 100 receives the image listing from the media server (515). The image listing can be transferred to the media client 100 in one or more packets, such as over a network connection, or as a file, such as through a direct connection. In an implementation, the image listing can be structured as a database, such as a binary database or an extensible markup language (XML) database. In an implementation, the media server can be configured to track changes to the information included in the image listing that arise after the image listing has been transferred to the media client 100. Further, the media server can provide updates to the media client 100 identifying the changed information when a change occurs or periodically. Alternatively, the media client 100 can request updates to the image listing from the media server.

The image listing includes information that can be used by the media client 100 to request one or more images from the media server. For example, the image listing can include designators identifying the one or more images, such as a unique identifier and/or a file name and directory path. Further, the image listing can include additional metadata describing the images available on the media server, such as file type, file size, date of creation, and owner.

The media client 100 also can determine whether any preferences relating to the display of images have been set on the media client 100 (520). For example, the media client 100 can include one or more default image display preferences, such as slide show options and file settings. One or more image display preferences also can be modified by a user. If one or more preferences relating to the display of images have been set, the media client 100 can apply the image preferences to the image listing received from the media server (525). For example, one or more images can be excluded from a displayed listing of images based on the image preferences. In an implementation, the listing of images can be restricted to files of one or more predetermined formats, such as JPEG, BMP, GIF, TIFF, and PNG. Further, the image listing received from the media server can be organized in accordance with the image preferences.

In an implementation, the media client 100 also can be configured to adopt one or more preferences or settings specified at the media server over one or more conflicting preferences or settings specified at the media client 100. For example, a setting associated with a slide show available on the media server, such as an image transition setting, can override a corresponding preference or setting on the media client 100. Thus, a particular type of image transition used in a slide show streamed from the media server can be retained when the slide show is presented by the media client 100.

If no preferences relating to the display of images have been set, or once the image preferences have been applied to the image listing, the media client 100 can display the list of available images to a user in a user interface (530). The image listing also can be stored at the media client 100, such as for a predetermined amount of time or until the occurrence of a predetermine event, such as terminating the connection with the media server. Thus, the list of available images can be generated from the stored image listing, including any updates received from the media server, without having to issue an additional request for an image listing.

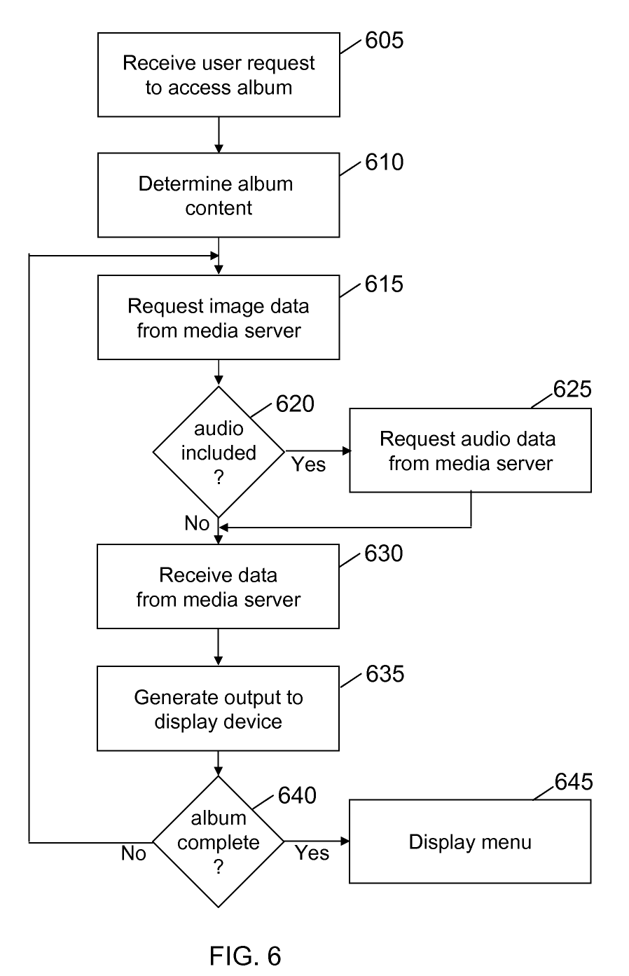

FIG. 6 shows a flowchart for streaming images to a media client for presentation on a display device. The media client 100 can receive a request from a user to access an album containing one or more images, such as through selection of a menu option (605). A user can request to access any album presented in a listing, such as the photos menu 400. Further, the album listing can be arranged as a single level of albums or as a hierarchy of albums.

The media client 100 determines the content of the requested album, such as by accessing the image listing received from the media server (610). Based on the album content, the media client 100 requests image data from the media server (615). For example, the media client 100 can transmit a request to the media server identifying a first image included in the album. The request can be structured as an HTTP request identifying the image to be transmitted, such as by filename and path. Alternatively, any other protocol for requesting and transmitting data can be used, including DPAP. Further, successive requests can be transmitted before a previously transmitted request has been satisfied.

The media client 100 also can be configured to generate requests to the media server for image data based on one or more preferences and settings. For example, the images included in an album can be requested in sequential order according to the image listing or in random order as specified by the configuration of the media client 100. Other aspects of a presentation also can be controlled through preferences and settings, such as the duration for which an image is presented, transitions between images, and visual effects, including panning, zooming, rotating, focus, brightness, and fading.

Further, the media client 100 can determine whether audio information is to be included in the presentation (620). For example, one or more audio clips, such as music or narration, can be presented with the one or more images included in the album. Further, the one or more audio clips can correspond to the album being presented, such as an associated playlist, or can be selected by the media client 100 during the presentation. If audio information is to be included in the presentation, the media client 100 also can generate requests to the media server for the audio data (625). As with image data, the requests can be structured as HTTP requests identifying the audio information to be transmitted. Alternatively, any other protocol can be used, including DAAP. In another implementation, the media client 100 also can be configured to select audio information stored on the media client 100 for playback during the presentation.

The media client 100 receives the requested data from the media server (630). In addition to the image data and, if requested, audio data, the media client 100 also can receive metadata and control data. Further, the data associated with the presentation generated by the media client 100 can be streamed, such that the image and audio data associated with a first portion of a presentation can be output while image and audio data associated with a second portion of a presentation are being requested and/or received. Additionally, the image data and audio data can be transmitted over separate channels. Alternatively, the image data and audio data can be transmitted over a shared channel, such that the image data associated with one or more images can be interleaved with the audio data.

Output is generated using the data received from the media server and directed to one or more display devices, such as a monitor and one or more speakers (635). Further, the output can be generated in accordance with one or more settings and/or preferences. The media client 100 also determines whether presentation of the album is complete (640). For example, the media client 100 can determine that presentation of an album is complete when all of the images in the album have been displayed for the appropriate amount of time and any audio information corresponding to the images has been played. In an implementation, presentation of an album can be repeated for a predetermined number of times or until input is received from a user stopping the presentation. Thus, the media client 100 also can be configured to determine that presentation of the album is complete when input canceling the presentation is received, such as from a user.

If the media client 100 determines that presentation of an album is not complete, the media client 100 requests image data from the media server corresponding to one or more remaining images (615). In an implementation, the media client 100 does not transmit additional request for image data to the media server after all of the images in an album have been received, such as during repetition of a presentation. Upon determining that presentation of the album is complete, the media client 100 can display a menu on the display device (645).

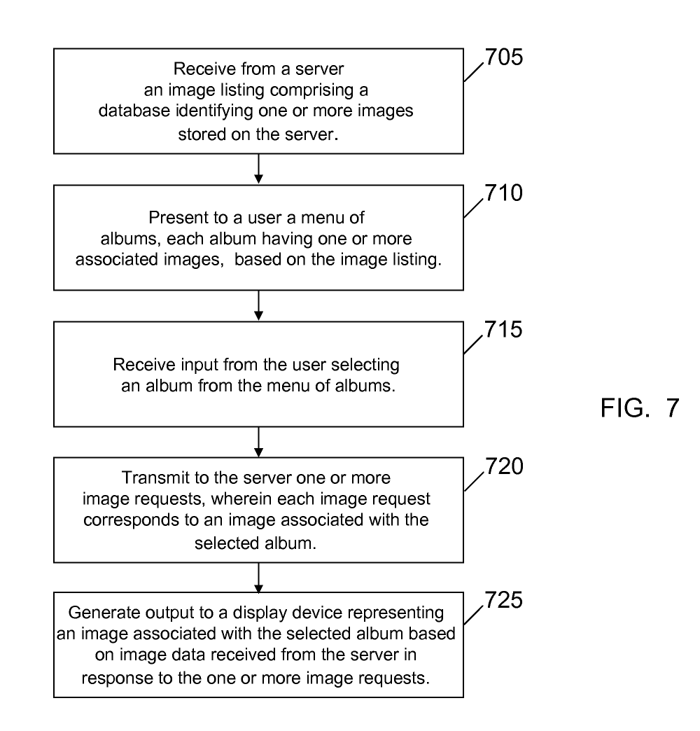

FIG. 7 shows a flowchart for a method of streaming photos to a media device. In generating the streaming presentation, an image listing is received from a server, wherein the image listing comprises a database identifying one or more images stored on the server (705). A menu of albums, each album having one or more associated images, based on the image listing is presented to a user (710). Input selecting an album from the menu of albums is received from the user (715). One or more image requests are transmitted to the server, wherein each image request corresponds to an image associated with the selected album (720). Output is generated to a display device representing an image associated with the selected album based on image data received from the server in response to the one or more image requests (725).

A number of implementations have been disclosed herein. Nevertheless, it will be understood that various modifications may be made without departing from the spirit and scope of the claims. Accordingly, other implementations are within the scope of the following claims.

What is claimed is:

1. A method of streaming images to a media device, the method comprising:
receiving from a server an image listing comprising a database identifying one or more images stored on the server;
presenting to a user a menu of albums, each album having one or more associated images, based on the image listing;
receiving input from the user selecting an album from the menu of albums;
transmitting to the server one or more image requests, wherein each image request corresponds to an image associated with the selected album; and
generating output to a display device representing an image associated with the selected album based on image data received from the server in response to the one or more image requests.

2. The method of claim 1, further comprising:
receiving an update to the image listing received from the server; and
applying the update to the image listing before presenting the menu of albums.

3. The method of claim 1, further comprising:
processing the image listing in accordance with one or more user preferences before presenting the menu of albums.

4. The method of claim 1, wherein the image listing comprises one of a binary database and an extensible markup language database.

5. The method of claim 4, wherein a unique identifier is associated with each image included in the image listing.

6. The method of claim 1, further comprising:
identifying an audio clip associated with the selected album; and
transmitting to the server one or more audio requests, wherein each audio request corresponds to the identified audio clip.

7. The method of claim 1, wherein the one or more image requests comprise Hypertext Transfer Protocol requests.

8. A computer program product, encoded on a computer-readable medium, operable to cause data processing apparatus to perform operations comprising:
receiving from a server an image listing comprising a database identifying one or more images stored on the server;
presenting to a user a menu of albums, each album having one or more associated images, based on the image listing;
receiving input from the user selecting an album from the menu of albums;
transmitting to the server one or more image requests, wherein each image request corresponds to an image associated with the selected album; and
generating output to a display device representing an image associated with the selected album based on image data received from the server in response to the one or more image requests.

9. The computer program product of claim 8, further operable to cause data processing apparatus to perform operations comprising:
receiving an update to the image listing received from the server; and
applying the update to the image listing before presenting the menu of albums.

10. The computer program product of claim 8, further operable to cause data processing apparatus to perform operations comprising:
processing the image listing in accordance with one or more user preferences before presenting the menu of albums.

11. The computer program product of claim 8, wherein the image listing comprises one of a binary database and an extensible markup language database.

12. The computer program product of claim 11, wherein a unique identifier is associated with each image included in the image listing.

13. The computer program product of claim 8, further operable to cause data processing apparatus to perform operations comprising:
identifying an audio clip associated with the selected album; and
transmitting to the server one or more audio requests, wherein each audio request corresponds to the identified audio clip.

14. The computer program product of claim 8, wherein the one or more image requests comprise Hypertext Transfer Protocol requests.

15. A system comprising:
a server;
a display device;
a user interface; and
a media device configured to perform operations comprising:
receiving from the server an image listing comprising a database identifying one or more images stored on the server;
presenting on the display device a menu of albums, each album corresponding to one or more images, based on the image listing;
receiving through the user interface input selecting an album from the menu of albums;
transmitting to the server one or more image requests, wherein each image request corresponds to an image associated with the selected album; and
generating output to the display device representing an image associated with the selected album based on image data received from the server in response to the one or more image requests.

16. The system of claim 15, wherein the media device configured to perform operations comprising:
receiving an update to the image listing received from the server; and
applying the update to the image listing before presenting the menu of albums.

17. The system of claim 15, wherein the media device configured to perform operations comprising:
processing the image listing in accordance with one or more user preferences before presenting the menu of albums.

18. The system of claim 15, wherein the image listing comprises one of a binary database and an extensible markup language database.

19. The system of claim 18, wherein a unique identifier is associated with each image included in the image listing.

20. The system of claim 15, wherein the media device configured to perform operations comprising:
identifying an audio clip associated with the selected album; and
transmitting to the server one or more audio requests, wherein each audio request corresponds to the identified audio clip.

21. The system of claim 15, wherein the one or more image requests comprise Hypertext Transfer Protocol requests.
